(19) United States
(12) Patent Application Publication
(10) Pub. No.: US 2026/0267648 A1
(43) Pub. Date: Sep. 10, 2026

(54) METHOD, APPARATUS, DEVICE, MEDIUM AND PRODUCT FOR PROCESSING STACK INFORMATION

(71) Applicant: Beijing Zitiao Network Technology Co., Ltd., Haidian District (CN)

(72) Inventor: Yaoyuan ZHENG, Beijing (CN)

(21) Appl. No.: 19/562,598

(22) Filed: Mar. 10, 2026

(30) Foreign Application Priority Data
Mar. 10, 2025 (CN) 202510279468.7

(51) Int. Cl. G06F 9/30

(52) U.S. Cl. CPC G06F 9/30134; G06F 9/3009

(57) ABSTRACT

Embodiments of the present disclosure relate to a method, an apparatus, a device, a medium, and a product for processing stack information. The method includes obtaining a stack information item of a first thread in response to the first thread calling an application programming interface for switching a thread. The method further includes transferring the stack information item of the first thread to a second thread after switching the first thread to the second thread via the application programming interface. The method further includes storing the stack information item in a storage space allocated for the second thread.

### CROSS-REFERENCE TO RELATED APPLICATIONS

This application claims priority to Chinese Application No. 202510279468.7 filed on Mar. 10, 2025, the disclosure of which is incorporated herein by reference in its entirety.

### FIELD

Embodiments of the present disclosure generally relate to the field of multithreaded programming, and more specifically to a method, an apparatus, a device, a medium and a product for processing stack information.

### BACKGROUND

The rapid development of mobile phone applications and the mobile Internet has greatly changed people’s lifestyle. As smart phones prevail, various applications cover multiple fields such as social interaction, shopping, entertainment, education and health, and provide convenient services and rich experience. The rapid development of mobile Internet makes information acquisition, remote work and so on become daily, thereby improving the information processing efficiency.

At present, with the rapid development of mobile phone applications and mobile Internet, user privacy protection has become a crucial topic. As data leakage events occur frequently, users pay more and more attention to personal information security. Therefore, developers need to take more stringent data protection measures to ensure that user privacy is not compromised.

### SUMMARY

Embodiments of the present disclosure provide a method, an apparatus, a device, a medium, and a product for processing stack information.

According to a first aspect of the present disclosure, there is provided a method for processing stack information. The method includes obtaining a stack information item of a first thread in response to the first thread calling an application programming interface for switching a thread. The method further includes transferring the stack information item of the first thread to a second thread after switching the first thread to the second thread via the application programming interface. The method further includes storing the stack information item in a storage space allocated for the second thread.

According to a second aspect of the present disclosure, there is provided an apparatus for processing stack information. The apparatus includes a stack obtaining module, configured to obtain a stack information item of a first thread in response to the first thread calling an application programming interface for switching a thread; a thread switching module, configured to transfer the stack information item of the first thread to a second thread after switching the first thread to the second thread via the application programming interface; and a thread storing module, configured to store the stack information item in a storage space allocated for the second thread.

According to a third aspect of the present disclosure, there is provided an electronic device, and the electronic device includes at least one processor; a memory configured to store at least one program, wherein the at least one program, when executed by the at least one processor, causes the at least one processor to implement the method according to the first aspect of the present disclosure.

In a fourth aspect of the present disclosure, there is provided a computer readable storage medium storing a computer program thereon, wherein the computer program, when executed by a processor, implements the method according to the first aspect of the present disclosure.

In a fifth aspect of the present disclosure, there is provided a computer program product. The computer program product includes a computer program, wherein the computer program, when executed by a processor, implements the method according to the first aspect of the present disclosure.

It will be appreciated that the content described in Summary part is not intended to define essential or important features of embodiments of the present disclosure or to limit the scope of the present disclosure. Other features of the present disclosure will be made apparent by the following description.

### BRIEF DESCRIPTION OF THE DRAWINGS

The above and other objects, features and advantages of the present disclosure will become more apparent by reference to the following detailed description of example embodiments of the present disclosure in conjunction with the accompanying drawings, wherein the same reference numerals usually denote the same parts in the example embodiments of the present disclosure.

FIG. 1 illustrates a schematic diagram of an example environment in which apparatuses and/or methods according to some embodiments of the present disclosure may be implemented;

FIG. 2 illustrates a schematic diagram of an example method for processing stack information according to some embodiments of the present disclosure;

FIG. 3 illustrates a schematic diagram of an example method for obtaining complete stack information according to some embodiments of the present disclosure;

FIG. 4 illustrates a schematic diagram of an example method of outputting complete stack information according to some embodiments of the present disclosure;

FIG. 5 illustrates a schematic diagram of an example method for allocating storage spaces according to some embodiments of the present disclosure;

FIG. 6 illustrates a schematic block diagram of an apparatus for processing stack information according to some embodiments of the present disclosure;

FIG. 7 illustrates a schematic block diagram of an example device adapted for implementing multiple embodiments of the present disclosure.

### DETAILED DESCRIPTION OF EMBODIMENTS

It may be appreciated that data (including but not limited to the data itself, acquisition or use of data) involved in the technical solution should comply with requirements in relevant laws and regulations and relevant provisions.

It is to be understood that, before the technical solutions disclosed in the embodiments of the present disclosure are used, a user should be informed of a type, a use range, a use scenario, etc. of personal information involved in the present disclosure and authorization should be obtained from the user in an appropriate manner according to relevant laws and regulations.

For example, when the user’s active request is received, prompt information is sent to the user to explicitly prompt the user that the operation requested to be performed will require the acquisition and use of the user’s personal information. Accordingly, the user may autonomously decide according to the prompt information whether to provide his personal information to software or hardware, such as an electronic device, an application, a server or a storage medium, which performs the operation of the technical solution of the present disclosure.

As an optional but non-limiting implementation, a manner of sending the prompt information to the user in response to receiving the user’s active request may for example be a pop-up window in which the prompt information may be presented in a text. In addition, the pop-up window may also carry a selection control for the user to select “agree” or “disagree” to provide the personal information to the electronic device.

It may be appreciated that the above process of notifying and obtaining the user’s authorization is merely illustrative and not intended to limit implementations of the present disclosure, and that other manners satisfying relevant laws and regulations may also be applied to implementations of the present disclosure.

Hereinafter, embodiments of the present disclosure will be described in more detail with reference to the figures. Although some embodiments of the present disclosure are shown in the figures, it is to be understood that the present disclosure may be implemented in various forms and should not be construed as being limited to the embodiments illustrated herein; rather, these embodiments are provided to enable more thorough and complete understanding of the present disclosure. It should be appreciated that the drawings and embodiments of the present disclosure are for illustrative purposes only and are not intended to limit the scope of the present disclosure.

In the description of the embodiments of the present disclosure, the term “include” or like words should be considered as being open-ended, i.e., “include but not limited to”. The term “based on” should be understood as meaning “based at least in part on”. The terms “one embodiment” or “the embodiment” should be understood as “at least one embodiment”. The terms “first”, “second” and the like may refer to different or identical objects unless expressly stated otherwise. Other explicit and implicit definitions may also be included below.

As stated above, with the rapid development of mobile phone applications and mobile Internet, user privacy protection has become a crucial topic. To effectively protect user privacy, it is usually necessary to obtain stack information of each call of a sensitive Application Programming Interface (API) to determine a caller and its intent. However, there are still many challenges in using the stack information for privacy protection-related behavior analysis currently.

Normally only the stack information of the current thread can be obtained through the system application programming interface. However, in an actual application scenario, a caller might call the sensitive application programming interface after switching threads multiple times. The case of such multi-thread switching, plus the limitations of the system application programming interface, makes it impossible to accomplish the acquisition of complete stack information, thereby affecting the actual effect of privacy protection.

For example, thread switching is a very common operation in a complex application. The caller might frequently switch between multiple threads, so that stack information is scattered in different threads. A existing system API can only provide stack information of the current thread, and cannot obtain stack information across threads. This limitation makes it impossible to obtain a complete call stack in a multithreaded environment. Since the stack information cannot be obtained across threads, the finally-obtained stack information is incomplete. Such incompleteness directly affects the behavior analysis of a call for the sensitive API, thereby weakening the actual effect of privacy protection.

To this end, embodiments of the present disclosure provide a method for processing stack information. In this method, if a first thread calls an application programming interface for switching a thread, a computing device may obtain a stack information item of the first thread. Then, the computing device transfers the stack information item of the first thread to a second thread after switching the first thread to the second thread via the application programming interface. Then, the stack information item is stored in a storage space allocated to the second thread. By this method, upon thread switching, the stack information of a previous thread is transferred to the current thread, so that the stack information of the previous thread is stored in the current thread, thereby the complete stack information can be obtained in the current thread, and the user’s experience is improved.

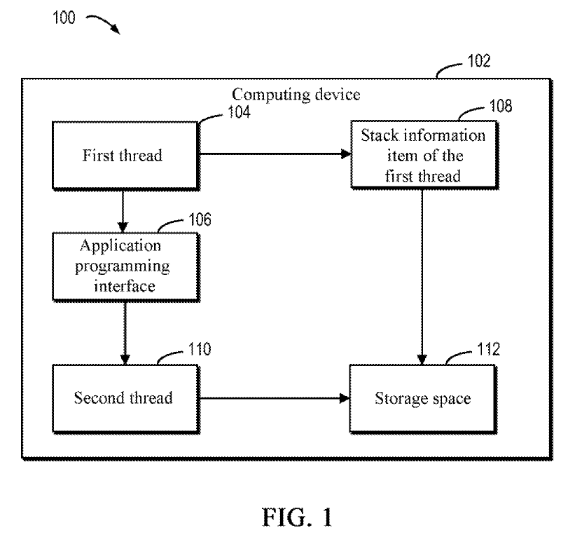

Embodiments of the present disclosure will be described in further detail below with reference to the accompanying drawings. FIG. 1 illustrates an example environment in which apparatuses and/or methods of embodiments of the present disclosure can be implemented. In an environment 100, a computing device 102 may obtain complete stack information for each thread to analyze the obtained stack information.

Examples of the computing devices 102 include, but are not limited to, a personal computer, a server computer, a hand-held or laptop device, a mobile device (such as a mobile telephone, a Personal Digital Assistant (PDA), a media player, etc.), a multi-processor system, a consumer electronic device, a minicomputer, a mainframe computer, a distributed computing environment that include any of the foregoing systems or devices, etc.

As shown in FIG. 1, a first thread 104 runs in the computing device 102, and the first thread 104 may be any thread of an application running in the computing device 102. For example, the first thread 104 may be a thread that accesses a user interface, and an interface of the application used by a user may be accessed through the thread. A stack information item 108 of the first thread may be obtained by calling a system API in an operating system of the computing device 102. However, the system API can only obtain the stack information of the first thread 104. If the first thread 104 switches to another thread, the system API can only obtain stack information of the currently-running other thread API while the other thread is executed.

To avoid the problem that the stack information of the first thread 104 cannot be obtained through the system API after the first thread 104 is switched to another thread, the computing device 102 may obtain the stack information item 108 of the first thread in advance when switching the thread. For example, an API for switching thread is intercepted, and the above problem is solved through a hook mechanism. At this time, the transferring of thread stack information is achieved by setting point positions, i.e., hooks, at some key positions in the application programming interface of the switching thread, and further performing some processing by a function or program of these point positions.

For example, when the first thread 104 calls the application programming interface 106, the computing device 102 intercepts the application programming interface 106 that switches threads and uses the set plurality of key point positions to implement the transfer of the stack information. At this time, after the first thread 104 calls the application programming interface 106 that switches threads, one point position may be set before thread switching. The operation at this point position will obtain the stack information item 108 of the first thread through a system API call. The stack information item typically includes key information such as a stack pointer of the current thread, a function call chain, local variables, and an execution state. Caller information and a call intent of some application programming interfaces may be determined through the stack information item 108 of the first thread. Therefore, whether the caller has a permission to obtain some critical information may be determined by analyzing the stack information. For ease of description, the stack information item 108 of the first thread may also be referred to as a first stack information item.

Then, the first thread 104 is switched to the second thread 110 via the application programming interface 106. For example, the second thread may perform a thread task that downloads data information such as pictures for the user. At this time, the second thread 110 begins running and the first thread enters a suspended or paused state. Furthermore, a point position, i.e., a second point position, is set before the tread task of the second thread is performed, to transfer the stack information item 108 of the first thread returned by the system application programming interface to the second thread 110, and store the received stack information item 108 of the first thread in a local storage space 112, i.e., a first storage space. The first storage space is a memory region allocated for the second thread and used for temporarily storing the stack information of the first thread. This ensures that the stack information of the first thread can also be obtained even on the second thread. After the switching is completed, the second thread begins executing its corresponding task.

Additionally, after the thread switching and after the completion of the execution of the thread task of the second thread, a third point position may be set. The stack information of the first thread stored in the storage space 112 of the second thread may be removed through a program or function set at the third point position. The so doing is to release the memory space and ensure the stack information does not occupy unnecessary system resources. If the stack information is not needed any more, the system will clear it to avoid memory leaks.

In some embodiments, if the second thread 110 continues to call another thread, the stack information item of the second thread 110 is obtained in a manner similar to what is described above. After the second thread 110 is switched to a third thread, the stack information of the second thread 110 is transferred to the third thread and stored in a local storage space allocated for the third thread. By analogy, when threads call each other, the stack information item of the previous thread is stored in the currently executing thread.

Additionally, when the first thread 104 is switched to the second thread, it may be further confirmed whether there is stack information calling a previous thread of the first thread in the local storage space of the first thread. If there is the stack information of the previous thread, an address of the local storage space of the first thread is also transferred to the second thread and stored in the storage space 112. When the second thread is switched to another thread, the address of the storage space 112 is also transferred to the next thread and stored in the storage space of the next thread. These addresses may be used as pointers pointing to the previous storage spaces in the storage spaces, so that the storage spaces storing the stack information for these threads form a linked list.

If the complete stack information of the second thread 110 needs to be obtained, the stack information item for the current second thread may be obtained through the system API and then the stack information item of the first thread may be obtained through the storage space of the second thread. If the storage space 112 also stores the address of the storage space of the first thread, the stack information in the storage space of the first thread may also be obtained via the address, and by analogy, stack information items of all called threads may be obtained to obtain the complete stack information. Then, the complete stack information may be used to analyze the caller and the intention of the sensitive API in the threads, so that privacy can be effectively protected.

By this method, the stack information is saved and transferred in the switching phase of multiple threads, so that all stack information can be obtained completely after thread switching. This mechanism effectively reduces the loss of stack information caused by thread switching, improves the stability, safety and efficiency in executing the multithreaded tasks, avoids the problem of memory leaks, optimizes the management of system resources, and improves the reliability and performance of multithreaded processing tasks.

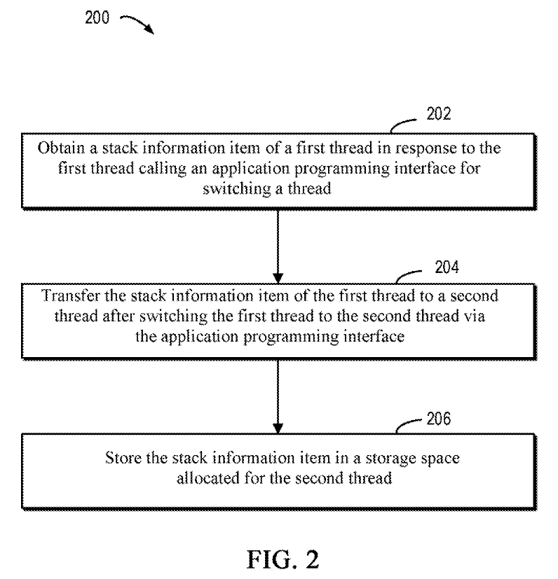

A schematic diagram of an example environment in which the apparatuses and/or methods of some embodiments of the present disclosure can be implemented is described above with reference to FIG. 1. Reference is made below to FIG. 2 to describe a schematic diagram of an example method for processing stack information according to some embodiments of the present disclosure. The method of FIG. 2 may be performed by the computing device 102 of FIG. 1 or any suitable computing device.

As shown in FIG. 2, in an e example method 200, at block 202, the computing device 102 obtains a stack information item of a first thread in response to the first thread calling an application programming interface for switching a thread. In order to transfer the stack information item of the first thread to the following second thread, the stack information item of the first thread needs to be obtained after calling the application programming interface for switching threads. For ease of description, the stack information item of the first thread may also be referred to as a first stack information item.

For example, if the first thread calls the application programming interface for switching a thread, the system application programming interface may be called before thread switching, and the stack information item for the first thread returned by the system application programming interface may be obtained. For example, a plurality of point positions may be set in the API of switching thread, through a Hook mechanism, e.g., one point position is set before the thread is switched. When the program runs to this point position, the system application programming interface is called by executing a corresponding program or function to obtain the stack information item of the first thread.

At block 204, the stack information item of the first thread is transferred to the second thread after the first thread is switched to the second thread via the application programming interface. In order to obtain the stack information item of the first thread at the second thread, it is necessary to, after switching the first thread 104 to the second thread 110 via the application programming interface 106, transfer the stack information item 108 of the first thread to the second thread. For example, after the thread switching, a point position is set by the Hook mechanism before the thread task of the second thread is executed. When the program is executed to this point position, the obtained stack information item of the first thread is transferred to the second thread 110 by performing a corresponding program or function.

At block 206, the stack information item is stored in the storage space allocated for the second thread. After the second thread has obtained the stack information item of the first thread, the stack information item of the first thread is stored in the storage space 112 allocated for the second thread. For ease of description, the storage space 112 storing the first stack information item may also be referred to as a first storage space.

In some embodiments, if the first thread 104 is not an initial thread or a thread called by other threads, it may be further determined whether a second stack information item calling a previous thread of the first thread is stored in a second storage space corresponding to the first thread when the stack information item of the first thread is transferred. If the second stack information item is stored, an address of the second storage space may be obtained, and then the address and the stack information item of the first thread are transferred to the second thread 110 and stored in the storage space 112 of the second thread. Therefore, the storage space 112 may be linked to the second storage space by using the obtained address of the second storage space as a pointer. By analogy, if the second thread 110 also calls another thread, the address of the storage space 112 and the stack information item of the second thread will be stored in the storage space of the next thread called by the second thread 110, and the address of the storage space 112 will serve as a pointer pointing to the storage space 112 in the storage space of the next thread. Therefore, these storage spaces are linked through the stored addresses to form a linked list.

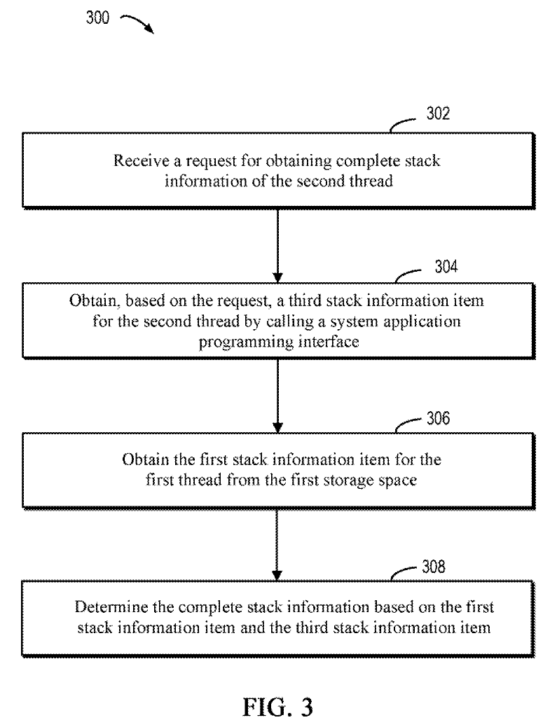

This linked list may be used to obtain the complete stack information of a thread, and a process of obtaining the complete stack information of a thread will be described below with reference to FIG. 3. In some embodiments, if the task of the called thread is completed, the stack information item in the storage space for the thread may be deleted. For example, if the task of the second thread is completed, the stack information item in the storage space for the thread may be deleted.

By this method, the stack information before thread switching is stored in each thread and then transferred in a new thread, and the stack information of the previous thread and the current thread is linked by the linked list structure, thereby facilitating obtaining the complete stack information. When faced with the call for the sensitive application programming interface, a comprehensive analysis may be made to better protect the user’s privacy and improve the user’s experience.

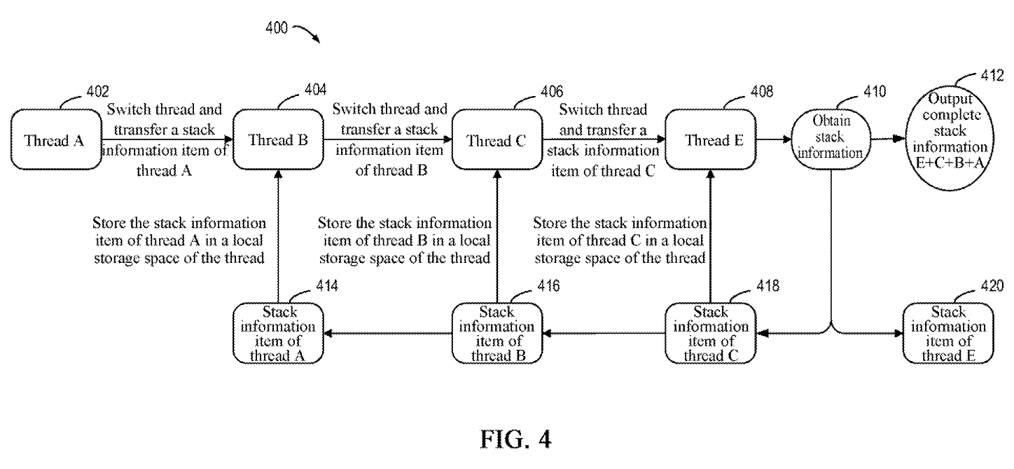

A schematic diagram of an example method of processing stack information according to some embodiments of the present disclosure is described above in with reference to FIG. 2. Reference is made below to FIG. 3 to describe a schematic diagram of an example method for obtaining complete stack information according to some embodiments of the present disclosure. An example method 300 in FIG. 4 may be processed by the computing device 102 in FIG. 1 or any suitable computing device.

At block 302, a request for obtaining complete stack information of a second thread is received. For example, to analyze a thread, the computing device 102 may receive a request for obtaining complete stack information of any thread, e.g., a request for obtaining the complete stack information of the second thread 110 in FIG. 1.

At block 304, a third stack information item for the second thread is obtained by calling a system application programming interface based on the request. For example, after the computing device 102 receives the request while the second thread is running, a third stack information item of the second thread may be obtained through the system application programming interface.

At block 306, the first stack information item for a first thread is obtained from the first storage space. In addition to obtaining the third stack information item of the second thread, the computing device 102 may further obtain the first stack information item for the first thread stored in the storage space 112.

At block 308, the complete stack information is determined based on the first stack information item and the third stack information item. After having obtained the first stack information item and third stack information item, the computing device 102 may use them to determine the complete stack information.

Upon determining the complete stack information, the computing device 102 may determine whether an address of the second storage space for the first thread exists in the first storage space. If the address of or a pointer that can point to the storage space of the first thread is not stored in the storage space 112, this indicates that the first thread is an initial thread, so that the complete stack information of the second thread is composed of the first stack information item and the second stack information item. If there is an address for the second storage space in the first storage space, this indicates that the second stack information item calling a previous thread of the first thread is also stored in the second storage space of the first thread. At this time, the second stack information item in the second storage space may be obtained through the address. Then, the computing device 102 may generate the complete stack information using the first stack information item, the second stack information item and the third stack information item. For example, the information of the first stack information item, the second stack information item and the third stack information item are combined to form the complete stack information. If the address of the storage space of a further thread is also stored in the second storage space, the stack information item of the further thread in the storage space is obtained according to the address. When the complete stack information is determined, it is also necessary to add the stack information item in the storage space. By analogy, upon obtaining stack information, stack information items of the relevant storage space need to be combined together.

Therefore, by the above method, the computing device may sequentially obtain the stack information item of a previous thread of the thread currently executing the task, and finally obtains the stack information of each thread on a call link by reversely traversing the linked list including the stack information items, and splice this stack information to obtain the complete stack information.

By this method, the complete stack information may be obtained by associating the stack information of the previous thread and the current thread through the addresses, and the user’s privacy is better protected and the user’s experience is improved when the sensitive application programming interface is called.

A schematic diagram of an example method for obtaining the complete stack information according to some embodiments of the present disclosure is described above with reference to FIG. 3. Reference is made below to FIG. 4 to describe a schematic diagram of an example method for obtaining complete stack information items according to some embodiments of the present disclosure. An example method 400 in FIG. 4 may be processed by the computing device 102 in FIG. 1 or any suitable computing device.

In the example method 400, at 402, thread A is executed. Before thread A is switched to another thread, a stack information item 414 of the current thread A may be obtained through the system application programming interface and the stack information item 414 of the current thread A is transferred to thread B after thread A is switched to thread B, and stored in a local storage space of thread B. At 404, thread B is executed. Before thread B is switched to another thread, a stack information item 416 of the current thread B may also be obtained through the system application programming interface, the stack information item 416 of the current thread B is transferred t to thread C after thread B is switched to thread C, and stored in a local storage space of thread C. At 406, thread C is executed. Before thread C is switched to another thread, a stack information item 418 of the current thread C may be obtained through the system application programming interface and the stack information item 418 of the current thread C is transferred to thread E after thread C is switched to thread E, and stored in a local storage space of thread E. Finally, at 408, thread E is executed. Additionally, during the storage of the stack information item, the address in the local storage space for storing the stack information item in the previous thread is also transferred to the local storage space in the next thread as a pointer pointing to the local storage space in the previous thread, thereby forming a linked list of local storage space.

If, at 410, the computing device receives a request to obtain the complete stack information of thread E, the stack information item 420 of thread E is first obtained through the system application programming interface, and then the stack information item of thread C is obtained from the local storage space of thread E. Then, reverse traversal is performed from a linked list node formed by the storage space to obtain the stack information item 416 of thread B and finally the stack information item 414 of thread A is obtained. Then, the complete stack information including the stack information item of thread E, the stack information item of thread C, the stack information item of thread B and the stack information item of thread A is output at 412. The information output at this time is the complete call stack information.

If thread E is the last thread, the stack information of thread C is removed from the local storage space of thread E if it is detected that execution of the task of the current thread has been completed.

The transferring the stack information item, storing the stack information item and deleting the stack information item described above may be implemented using the Hook mechanism by which the API for all thread switching in the system is handled. Generally, three point positions may be set for operation: a. before switching thread (point position 1): before switching thread, the stack information of the current thread is obtained through the system API. If the local storage space contains the stack information transferred from the previous thread, the stack information of the previous thread and the current thread is connected in the form of the linked list pointer. b. After switching thread and before the thread task is executed (point position 2): the stack information obtained from the previous thread is transferred to the next thread and stored in the local storage space. c. After switching thread, and after thread task is executed (point position 3): the stack information is removed from the local storage space after execution of the current thread task is completed.

It is ensured by this method that the stack information is saved and transferred correctly in the switching phase of multiple threads, so that all stack information can be obtained completely after thread switching. This mechanism effectively reduces the loss of the stack information caused by thread switching, improves the stability, security and efficiency in executing multithreaded tasks, avoids the problem of memory leakage, optimizes the management of system resources, and improves the reliability and performance of multithreaded processing tasks.

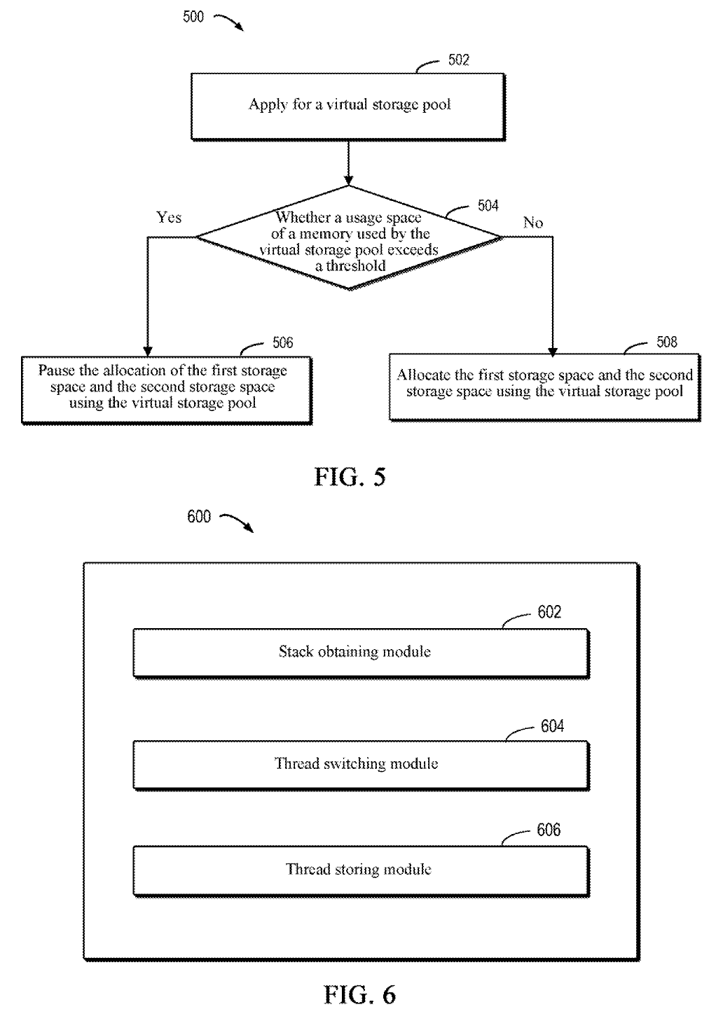

A schematic diagram of an example method of outputting complete stack information according to some embodiments of the present disclosure is described above with reference to FIG. 4. Reference is made below to FIG. 5 to describe a schematic diagram of an example method for allocating a storage space according to some embodiments of the present disclosure. The example method 500 in FIG. 5 may be processed by the computing device 102 in FIG. 1 or any suitable computing device.

Since the switching thread API is called frequently, a large peak memory required to store the stack might occur, memory overflow is likely to be caused, and the performance will be affected by frequent applications for the memory and release operations. To avoid the above problems, at block 502, a virtual storage pool is applied for. For example, an entire virtual storage pool is used to store the stack to avoid frequent applications for the memory and release operations. Then, the first storage space and the second storage space may be allocated using the virtual storage pool.

At block 504, it is determined whether a usage space of the memory used by the virtual storage pool exceeds a threshold. If the usage space of the memory exceeds the threshold, at block 506, allocation of the first storage space and the second storage space using the virtual storage pool is paused. If the usage space of the memory does not exceed the threshold, at block 508 the first storage space and the second storage space are allocated using the virtual storage pool. Therefore, if the usage space of the memory already exceeds an upper limit when the stack is obtained, the work is stopped to avoid memory overflow, and the normal operation can be resumed after the memory falls back.

FIG. 6 illustrates a schematic block diagram of an apparatus for processing stack information according to some embodiments of the present disclosure. As shown in FIG. 6, an apparatus 600 includes a stack obtaining module 602, configured to obtain a stack information item of a first thread in response to the first thread calling an application programming interface for switching a thread; a thread switching module 604, configured to transfer the stack information item of the first thread to a second thread after switching the first thread to the second thread via the application programming interface; and a thread storing module 606, configured to store the stack information item in a storage space allocated for the second thread.

In some embodiments, the stack obtaining module 602 includes: a system application programming interface calling module, configured to call a system application programming interface in response to the first thread calling the application programming interface for switching a thread; a target stack information item obtaining module, configured to obtain the stack information item for the first thread returned by the system application programming interface.

In some embodiments, the apparatus 600 further includes: a stack determination module, configured to determine whether a second stack information item calling a previous thread of the first thread is stored in a second storage space related to the first thread; an address determination module, configured to determine an address of the second storage space in response to the second stack information item being stored in the second storage space; an address transferring module, configured to transfer the address of the second storage space to the second thread; and an address storing module, configured to store the address of the second storage space in a first storage space.

In some embodiments, the apparatus 600 further includes: a request receiving module, configured to receive a request for obtaining complete stack information of the second thread; a target stack information item obtaining module, configured to obtain, based on the request, a third stack information item for the second thread by calling a system application programming interface; a stack reading module, configured to obtain the first stack information item for the first thread from the first storage space; and a stack information item merging module, configured to determine the complete stack information based on the first stack information item and the third stack information item.

In some embodiments, the stack information item merging module includes: an address verification module, configured to determine whether the address of the second storage space for the first thread exists in the first storage space; a previous stack information item obtaining module, configured to obtain the second stack information item for the previous thread based on the address in response to the address for the second storage space existing in the first storage space; and a stack information item merging module, configured to determine the complete stack information based on the first stack information item, the second stack information item, and the third stack information item.

In some embodiments, the stack information item merging module further includes: a virtual storage pool application module, configured to apply for a virtual storage pool; and a virtual storage space allocation module configured to allocate the first storage space and the second storage space using the virtual storage pool.

In some embodiments, the virtual storage space allocation module further includes: a memory threshold comparison module, configured to determine whether a usage space of a memory used by the virtual storage pool exceeds a threshold; and a virtual storage space determination module, configured to allocate the first storage space and the second storage space using the virtual storage pool in response to the usage space of the memory not exceeding the threshold.

In some embodiments, the virtual storage space determination module further includes module for pausing allocation of a virtual storage pool, configured to pause the allocation of the first storage space and the second storage space using the virtual storage pool in response to the usage space of the memory exceeding the threshold.

In some embodiments, the apparatus 600 further includes a stack information item deletion module, configured to delete the stack information item in the storage space in response to a task of the second thread being completed.

In some embodiments, the stack information item in the apparatus 600 includes call information of the first thread.

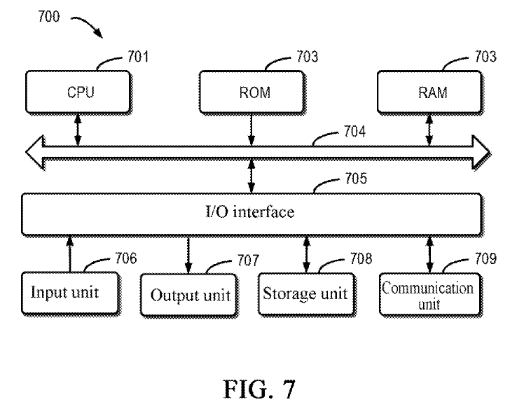

FIG. 7 illustrates a schematic block diagram of an example device 700 for implementing embodiments of the present disclosure. The computing device 102 in FIG. 1 may be implemented using the apparatus 700. As shown in FIG. 7, the device 700 includes a Central Processing Unit (CPU) 701 which may perform various suitable acts and processes in accordance with a computer program instruction stored in a Read Only Memory (ROM) 702 or a computer program instruction loaded from a storage unit 708 into a Random-Access Memory (RAM) 703. In the RAM 703, various programs and data needed by the operation of the device 700 are also stored. The CPU 701, the ROM 702, and the RAM 703 are connected to one another via a bus 704. An input/output (I/O) interface 705 is also coupled to the bus 704.

A plurality of components in the device 700 are connected to the I/O interface 705, and include: an input unit 706, such as a keyboard, a mouse, etc.; an output unit 707 such as various types of displays, speakers, and the like; a storage unit 708, such as a magnetic disk, an optical disk, etc.; and a communication unit 707 such as a network card, a modem, a wireless communication transceiver, etc. The communication unit 707 allows the device 700 to exchange information/data with other devices over a computer network such as the Internet and/or various telecommunication networks.

The various methods or processes such as methods 200, 300, 400 and 500 described above may be performed by the processing unit 701. For example, in some embodiments, the methods 200, 300, 400 and 500 may be implemented as a computer software program tangibly embodied on a machine-readable medium, such as storage unit 708. In some embodiments, part or all of the computer program may be loaded and/or installed on the device 700 via ROM 702 and/or communication unit 707. One or more acts in the example methods 200, 300, 400 and 500 described above may be performed when the computer program is loaded into the RAM 703 and executed by the CPU 701.

The present disclosure may relate to methods, apparatuses, systems and/or computer program products. The computer program product may include a computer readable storage medium having computer readable program instructions embodied thereon for performing various aspects of the present disclosure.

The computer-readable storage medium may be a tangible device that can hold and store instructions for use by an instruction execution device. The computer readable storage medium may be, for example but not limited to, an electrical storage device, a magnetic storage device, an optical storage device, an electromagnetic storage device, a semiconductor storage device, or any suitable combination of the above. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the case of the remote computer, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to implement aspects of the present disclosure.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processing unit of a general-purpose computer, special-purpose computer, or other programmable data processing apparatus to produce a machine, such that the instructions, which executed via the processing unit of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions executed on the computer, other programmable data processing apparatus, or other device implement the functions/acts specified in one or more blocks in the flowcharts and/or block diagrams.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special-purpose hardware and computer instructions.

The depictions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I claim:

1. A method for processing stack information, comprising:
obtaining a stack information item of a first thread in response to the first thread calling an application programming interface for switching a thread;
transferring the stack information item of the first thread to a second thread after switching the first thread to the second thread via the application programming interface;
storing the stack information item in a storage space allocated for the second thread.

2. The method according to claim 1, wherein obtaining the stack information item of the first thread comprises:
calling a system application programming interface in response to the first thread calling the application programming interface for switching a thread; and
obtaining the stack information item for the first thread returned by the system application programming interface.

3. The method according to claim 1, wherein the stack information item is a first stack information item, the storage space is a first storage space, and the method further comprises:
determining whether a second stack information item calling a previous thread of the first thread is stored in a second storage space related to the first thread;
determining an address of the second storage space in response to the second stack information item being stored in the second storage space;
transferring the address of the second storage space to the second thread;
storing the address of the second storage space in the first storage space.

4. The method according to claim 3, further comprising:
receiving a request for obtaining complete stack information of the second thread;
obtaining, based on the request, a third stack information item for the second thread by calling a system application programming interface;
obtaining the first stack information item for the first thread from the first storage space; and
determining the complete stack information based on the first stack information item and the third stack information item.

5. The method according to claim 4, wherein determining the complete stack information based on the first stack information item and the third stack information item comprises:
determining whether the address of the second storage space for the first thread exists in the first storage space;
obtaining the second stack information item for the previous thread based on the address in response to the address for the second storage space existing in the first storage space; and
determining the complete stack information based on the first stack information item, the second stack information item and the third stack information item.

6. The method according to claim 5, further comprising:
applying for a virtual storage pool; and
allocating the first storage space and the second storage space using the virtual storage pool.

7. The method according to claim 6, wherein allocating the first storage space and the second storage space using the virtual storage pool comprises:
determining whether a usage space of a memory used by the virtual storage pool exceeds a threshold; and
allocating the first storage space and the second storage space using the virtual storage pool in response to the usage space of the memory not exceeding the threshold.

8. The method according to claim 7, wherein allocating the first storage space and the second storage space using the virtual storage pool comprises:
pausing the allocation of the first storage space and the second storage space using the virtual storage pool in response to the usage space of the memory exceeding the threshold.

9. The method according to claim 1, further comprising:
deleting the stack information item in the storage space in response to a task of the second thread being completed.

10. The method according to claim 1, wherein the stack information item comprises call information of the first thread.

11. An electronic device, comprising:
at least one processor; and
a memory, configured to store at least one program, wherein the at least one program, when executed by the at least one processor, causes the at least one processor to:
obtain a stack information item of a first thread in response to the first thread calling an application programming interface for switching a thread;
transfer the stack information item of the first thread to a second thread after switching the first thread to the second thread via the application programming interface;
store the stack information item in a storage space allocated for the second thread.

12. The electronic device according to claim 11, wherein the at least one program causing the at least one processor to obtain the stack information item of the first thread further causes the at least one processor to:
call a system application programming interface in response to the first thread calling the application programming interface for switching a thread; and
obtain the stack information item for the first thread returned by the system application programming interface.

13. The electronic device according to claim 11, wherein the stack information item is a first stack information item, the storage space is a first storage space, and the at least one program further causes the at least one processor to:
determine whether a second stack information item calling a previous thread of the first thread is stored in a second storage space related to the first thread;
determine an address of the second storage space in response to the second stack information item being stored in the second storage space;
transfer the address of the second storage space to the second thread;
store the address of the second storage space in the first storage space.

14. The electronic device according to claim 13, wherein the at least one program further causes the at least one processor to:
receive a request for obtaining complete stack information of the second thread;
obtain, based on the request, a third stack information item for the second thread by calling a system application programming interface;
obtain the first stack information item for the first thread from the first storage space; and
determine the complete stack information based on the first stack information item and the third stack information item.

15. The electronic device according to claim 14, wherein the at least one program causing the at least one processor to determine the complete stack information based on the first stack information item and the third stack information item further causes the at least one processor to:
determine whether the address of the second storage space for the first thread exists in the first storage space;
obtain the second stack information item for the previous thread based on the address in response to the address for the second storage space existing in the first storage space; and
determine the complete stack information based on the first stack information item, the second stack information item and the third stack information item.

16. The electronic device according to claim 15, wherein the at least one program further causes the at least one processor to:
apply for a virtual storage pool; and
allocate the first storage space and the second storage space using the virtual storage pool.

17. The electronic device according to claim 16, wherein the at least one program causing the at least one processor to allocate the first storage space and the second storage space using the virtual storage pool further causes the at least one processor to:
determine whether a usage space of a memory used by the virtual storage pool exceeds a threshold; and
allocate the first storage space and the second storage space using the virtual storage pool in response to the usage space of the memory not exceeding the threshold.

18. The electronic device according to claim 17, wherein the at least one program causing the at least one processor to allocate the first storage space and the second storage space using the virtual storage pool further causes the at least one processor to:
pause the allocation of the first storage space and the second storage space using the virtual storage pool in response to the usage space of the memory exceeding the threshold.

19. The electronic device according to claim 11, wherein the at least one program further causes the at least one processor to:
delete the stack information item in the storage space in response to a task of the second thread being completed.

20. A computer readable storage medium storing a computer program thereon, wherein the computer program, when executed by a processor, causes the processor to:
obtain a stack information item of a first thread in response to the first thread calling an application programming interface for switching a thread;
transfer the stack information item of the first thread to a second thread after switching the first thread to the second thread via the application programming interface;
store the stack information item in a storage space allocated for the second thread.
